(19) United States
(12) Patent Application Publication
(10) Pub. No.: US 2003/0028440 A1
(43) Pub. Date: Feb. 6, 2003

(54) Method for pricing access to a plurality of software programs

(76) Inventors: Arthur L. Allen, Naples, FL (US); Marek Zejda, Naples, FL (US)

Correspondence Address: STEPTOE & JOHNSON LLP, 1330 CONNECTICUT AVENUE, N.W., WASHINGTON, DC, 20036, US

(21) Appl. No.: 09/920,617

(22) Filed: Aug. 3, 2001

(51) Int. Cl. G06F 17/60

(52) U.S. Cl. 705/26

(57) ABSTRACT

A method is provided for pricing access to a provider's library of a plurality of computer programs is provided. An appropriate capacity of a site of a interested user is determined. A price is determined based at least partially from the appropriate capacity. Access consistent with the price is offered to the interested user for access to the plurality of computer programs.

### BACKGROUND OF THE INVENTION

1. Field of the Invention

The present invention relates to a method for pricing and providing access to a plurality of software programs. More specifically, the present invention provides a method for providing access to a plurality of software programs based on a single price derived from a site capacity of a interested user.

2. Discussion of Background Information

Software has traditionally been made available by providers to interested users on a unit-by-unit, or suite-by-suite, basis. Since the price of different software varies, and since it is not known when a new product will arrive on the market, it is difficult for companies to properly budget for software acquisition and use.

Once installed, the software will require periodic maintenance and support from the provider, such as for upgrades. The cost for such support is typically a function of the site capacity of the user. However, the site capacity can be considerably larger than the size of the software, which can make the resulting maintenance price unduly large and burdensome.

### SUMMARY OF THE INVENTION

The present invention provides a pricing structure in which a library of software programs are made available to a interested user for a fee, where the fee is based on the system capacity of the interested user.

According to an embodiment of the invention, a method for pricing access to a provider's library of a plurality of computer programs is provided. The method includes determining an appropriate capacity of a site of a interested user, determining a price, based at least partially from the appropriate capacity, and offering, for the price, access of the interested user to the plurality of computer programs.

According to various preferable features of the above embodiment, the determining a price including consideration of a period of time for the access, and the offering including offering the access for the period of time. The determining an appropriate capacity preferably includes consideration of a current capacity of the site. The appropriate capacity is preferably determined to be one of a current capacity of the site, a projected future capacity of the site, and a value related by at least one of mathematical and abstract principles to one of the current capacity and the future capacity. The determining a price preferably reflects an inverse relationship between a cost-per-unit capacity and the appropriate capacity. If the appropriate capacity exceeds a threshold value, the determining a price preferably reflects an inverse relationship between a cost-per-unit capacity and the appropriate capacity. The determining a price preferably includes one of mathematically processing the appropriate capacity, and a modification of the mathematically processing the appropriate capacity.

According to another embodiment of the invention, a method for providing access to a provider's library of a plurality of computer programs is provided. The method includes determining an appropriate capacity of a site of a interested user, determining a price at least partially from a predetermined mathematical relationship between the price and at least the appropriate capacity and a period of time of desired access, receiving compensation consistent with the price, and providing access to the plurality of computer programs.

According to various preferable features of the above embodiment, the determining an appropriate capacity including consideration of a current capacity of the site. The appropriate capacity is preferably determined to be one of a current capacity of the site, a projected future capacity of the site, or a value related by at least one of mathematical and abstract principles to at least one of the current capacity and the future capacity. The determining a price preferably reflects an inverse relationship between the cost-per-unit capacity and the appropriate capacity, or, when the appropriate capacity exceeds a threshold value, the determining a price reflects an inverse relationship between the cost-per-unit capacity and the appropriate capacity. The determining a price preferably includes one of the mathematical processing of the appropriate capacity, and a modification of the mathematical processing of the appropriate capacity.

The method further preferably includes the providing access being effective to provide global access to the plurality of computer programs, but not to individual ones of the computer programs, determining a use fee to use one of the individual computer programs over a period of time based at least partially on a size of a sub-section of the site on which the one of the individual computer programs is resident. The sub-section is preferably a logical partition of the site or a collection of the individual computers on which the one of the individual computer programs is resident.

According to yet another embodiment of the invention, a method for providing access to a provider's library of a plurality of computer programs is provided. The method includes determining an appropriate capacity of a site of a interested user at least partially from at least one of a current capacity of the site and a future capacity of the site, determining a price at least partially from at least one of mathematical processing of at least the appropriate capacity and a period of time of desired access, and consulting a record of at least one previous mathematical processing of at least the appropriate capacity and a period of time of desired access, and receiving compensation consistent with the price, and providing access to any of the plurality of computer programs.

According to various preferably features of the above embodiment, the method further includes the providing access being effective to provide global access to the plurality of computer programs, but not to individual ones of the computer programs, and determining a use fee to use one of the individual computer programs over a period of time based at least partially on a size of a sub-section of the site on which the one of the individual computer programs is resident. The sub-section is preferably a logical partition of the site or a collection of the individual computers on which the one of the individual computer programs is resident.

The determining a price preferably reflects an inverse relationship between the cost-per-unit capacity and the appropriate capacity, or, when the appropriate capacity exceeds a threshold value, the determining a price preferably reflects an inverse relationship between the cost per unit capacity and the appropriate capacity.

The above-noted mathematical relationship is preferably:

k (AC)^{z}

where:

AC is the appropriate capacity, and

k and z are variables.

According to still yet another embodiment of the present invention, a method for pricing access to a plurality of libraries, each containing a plurality of computer programs, is provided. The method includes determining an appropriate capacity of a site of a interested user, determining a first price, based at least partially on a predetermined mathematical relationship to the appropriate capacity, for access to a first library of the plurality of libraries, determining a second price, based at least partially on a predetermined mathematical relationship to the appropriate capacity, for access to a second library of the plurality of libraries, offering, for the first price, access to the interested user for access to the first library, and offering, for the second price, access to the intended user for access to the second library.

According to various preferably features of the above embodiment, a content of computer programs in the first library partially overlaps with the second library, and the second library includes all of the programs in the first library.

Other exemplary embodiments and advantages of the present invention may be ascertained by reviewing the present disclosure and the accompanying drawings.

### BRIEF DESCRIPTION OF THE DRAWINGS

The present invention is further described in the detailed description which follows, in reference to the noted plurality of drawings by way of non-limiting examples of certain embodiments of the present invention, in which like numerals represent like elements throughout the several views of the drawings, and wherein:

FIG. 1 shows a representation of the preferred embodiment of the invention;

FIG. 2 is a flowchart of the methodology of the preferred embodiment of the present invention; and

FIG. 3 shows the preferred changes in price relative to an increase in appropriate capacity.

### DETAILED DESCRIPTION OF THE EXEMPLARY EMBODIMENT

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

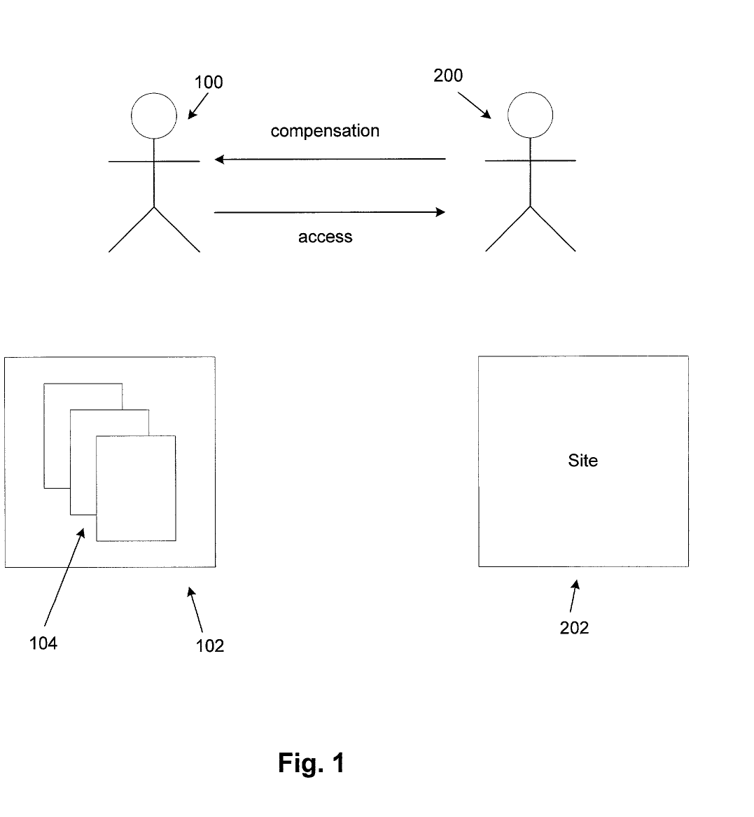

Referring now to FIG. 1, a provider 100 has a library 102, including a plurality of different computer software programs 104. An interested user 200 having a site 202 would like to install and use one or more of these programs 104.

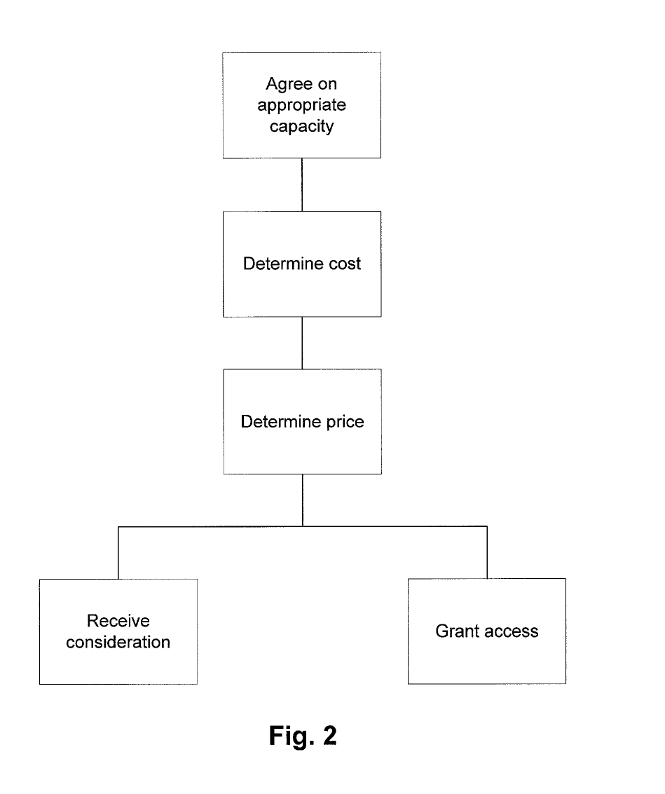

Referring now to FIG. 2, to establish a price (e.g., an access fee) for access (e.g., a license) to the library 102, provider 100 and interested user 200 agree on an appropriate capacity of site 202. Capacity is typically measured in units of Million Instructions Per Second (“MIPS”), although other units of measurement may be used. The appropriate capacity may represent the current capacity of the site 202, a projected capacity of site 202 for some point in the future, a capacity therebetween, or some other value related to the same (e.g., a negotiated capacity for price purposes that is based on any of the foregoing, rounding off the capacity, setting the capacity to the next highest or lowest tier, etc.).

The appropriate capacity is then input into a mathematical formula to produce a cost per unit time (i.e., cost=function (appropriate capacity)). This cost is then used to determine an appropriate price. According to the preferred embodiment of the invention, the above-noted formula is 47378×AC^{0.3953}, where AC represents the appropriate capacity noted above. This produces a cost based on time period of three years. A five-year price is preferably 1.5 times the three-year price.

From the cost, a price is then determined. Preferably, the cost equals the price (such that the 2 steps are actually one). However, the invention is not so limited, as the cost may be adjusted based upon other mathematical and/or abstract principles to reach the price. By way of non-limiting example, discounts, surcharges, or applicable taxes are mathematical adjustments. Non-limiting examples of abstract adjustments include reducing the price by an amount on a case-by-case basis (e.g., giving a price break to a longstanding customer, a customer that is either unwilling or unable to pay the calculated price, or the result of negotiation) or rounding off to some value.

Once the price is established, provider 100 offers it to interested user 200. If accepted, provider 100 will give interested user 200 access to the library of software programs 104 for the period of time. In return, interested user 200 will give, and provider 100 will receive, consideration consistent with the price. By way of non-limiting example, this consideration may equal the price, be a portion of the price based on a payment schedule, or other transfer as interested user 200 and provider 100 may agree upon. In addition, access may be granted before or after receipt of the consideration.

The appropriate capacity that is the basis of the above-noted price determination is preferably associated with a single data center for a site, which may or may not be networked into other areas. The price thus represents a “site license,” as it represents the price at which the site will receive access to the library 102. Preferably, the cost for each site is separately computed. However, one or more sites could be packaged, either by known techniques (e.g., a second site is 30% off, a third site is 50% off, etc.), combining the total MIPS, or some combination thereof.

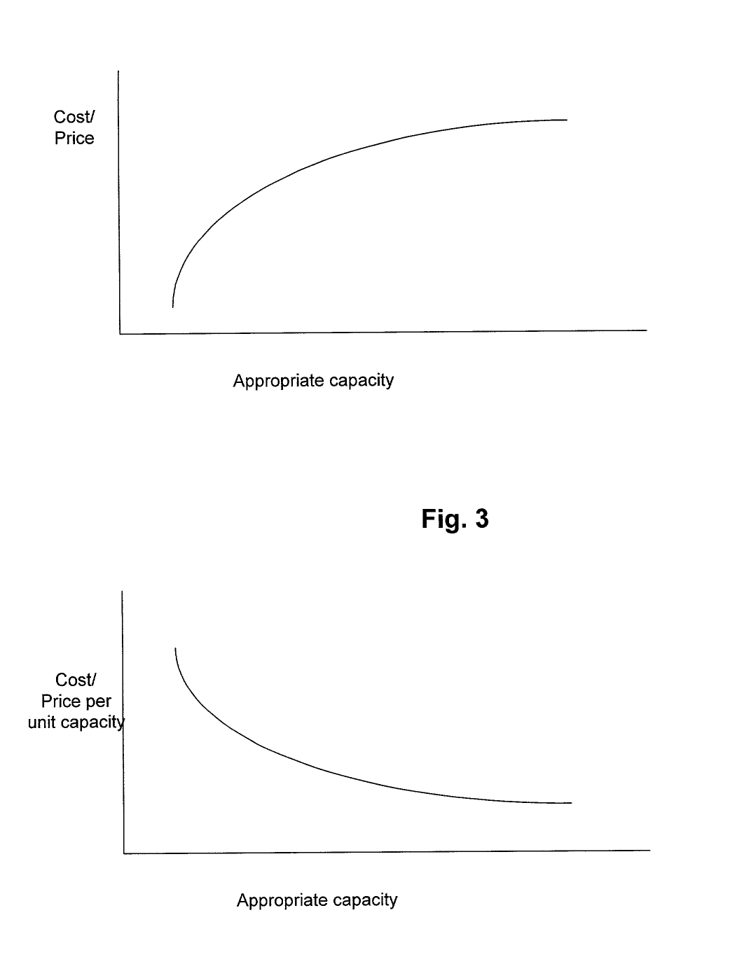

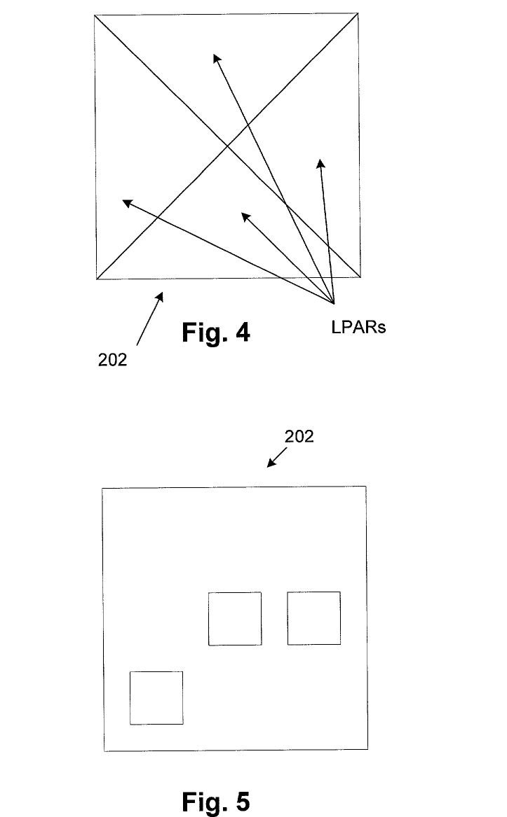

The formula noted above is but one way in which to arrive at the cost. The number and types of formulas are both numerous and variable, and within the scope and spirit of the invention. Any such formula should derive the cost from at least the appropriate capacity of site 202. Further, as shown in FIG. 3, the cost per MIPS preferably decreases as the appropriate capacity increases (although this may be stepwise or in non-linear progressions, such that no decrease in cost per MIPS would occur until after a threshold value). In addition, although the formula uses the appropriate capacity, other factors and/or adjustments may also be included in the formula (i.e., cost=function (appropriate capacity, k0 . . . . kn)). The formula may be adjusted to accommodate different periods of time.

In the preferred embodiment, library 102 includes all programs provided by provider 100. However, the invention is not so limited. Provider 100 may elect to establish a plurality of different libraries, which may contain unique software, or overlap with other libraries. By way of non-limiting example, a first library contains 100 programs, and a second library may contain the 100 programs plus an additional 20 programs. This division can create tiers of libraries, and thus different packages available to the interested user 200. The price for access to one or more of these libraries should remain based on the appropriate capacity as discussed above, although the formula and/or modifications to the resulting costs may be adapted as necessary.

The nature of the access provided may take many different forms. In one embodiment, the access allows an interested user 200 to obtain, download (by direct connection, disc, or other transfer), and use any and all software programs 104 from library 102 over the period of time. This can be thought of as a blanket license to all of the programs in the library. Preferably, the aforesaid access is subject to the normal limitations for the same, such as by contract or the laws of the United States.

In another embodiment, payment of the price provides access to the library, but not to the individual programs. A separate use fee is charged for use of any individual program over a period of time. The price for the use fee is preferably derived from the size of the sub-section or sub-sections of the site that uses the program (e.g., its size in MIPS). By way of non-limiting example, a logical partition (LPAR) of a site on which the individual program is used defines the size upon which the fee is based. Individual computers and/or networks could be used to define the size on which the program is used, although other factors may also be considered.

Preferably, the fee is either derived directly from the price or through a tier-based system, where the tiers are delineated by different MIP sizes. However, the invention is not so limited, as the fee may be adjusted based upon other mathematical and/or abstract principles to reach the fee. By way of non-limiting example, discounts, surcharges, or applicable taxes are mathematical adjustments. Non-limiting examples of abstract adjustments include reducing the fee by an amount on a case-by-case basis (e.g., giving a reduction to a longstanding customer, a customer that is either unwilling or unable to pay the fee, or the result of negotiation) or rounding off to some value.

Non-limiting examples of the above are shown in FIGS. 4 and 5. In FIG. 4, site 202 is separated into different LPARs. An individual program is resident on two of the four LPARs. The user fee would be based on the individual or collective sizes in MIPS capacity of the two LPARs, rather than the size of the entire site 202. In FIG. 5, the user fee is based only on the individual or collective capacity of the computers and networks on which the program is resident.

The use fee may also include/cover support, maintenance, training, and/or upgrades. Preferably, the interested user 200 could repeatedly pay the use fee to renew/extend the period of time of use. In theory, interested user 200 could use a program indefinitely by paying the one-time access fee (based on site capacity), and ongoing use fees (based on the program, rather than site capacity).

It is noted that the foregoing examples have been provided merely for the purpose of explanation and are in no way to be construed as limiting of the present invention. While the present invention has been described with reference to certain embodiments, it is understood that the words that have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

By way of non-limiting example, cost may be predetermined by pre-calculating cost for different capacities, such that the cost for an appropriate capacity of a specific type could be determined simply by consulting a preexisting record (e.g. table or database) of cost or price versus capacity (and/or other factors as may be considered). Such pre-processing falls within the scope and spirit of the invention.

What is claimed is:

1. A method for pricing access to a provider's library of a plurality of computer programs, comprising:
determining an appropriate capacity of a site of a interested user;
determining a price, based at least partially from the appropriate capacity; and
offering, for the price, access of the interested user to the plurality of computer programs.

2. The method of claim 1, further comprising:
said determining a price including consideration of a period of time for the access; and
said offering including offering the access for the period of time.

3. The method of claim 1, wherein said determining an appropriate capacity includes consideration of a current capacity of the site.

4. The method of claim 1, wherein said appropriate capacity is determined to be one of a current capacity of the site, a projected future capacity of the site, and a value related by at least one of mathematical and abstract principles to one of the current capacity and the future capacity.

5. The method of claim 1, wherein said determining a price reflects an inverse relationship between a cost-per-unit capacity and the appropriate capacity.

6. The method of claim 1, wherein, if said appropriate capacity exceeds a threshold value, said determining a price reflects an inverse relationship between a cost-per-unit capacity and the appropriate capacity.

7. The method of claim 1, said determining a price comprising one of mathematically processing the appropriate capacity, and a modification of said mathematically processing the appropriate capacity.

8. A method for providing access to a provider's library of a plurality of computer programs, comprising:
determining an appropriate capacity of a site of a interested user;
determining a price at least partially from a predetermined mathematical relationship between the price and at least the appropriate capacity and a period of time of desired access;
receiving compensation consistent with the price; and
providing access to said plurality of computer programs.

9. The method of claim 8, said determining an appropriate capacity including consideration of a current capacity of the site.

10. The method of claim 8, wherein said appropriate capacity is determined to be one of a current capacity of the site, a projected future capacity of the site, and a value related by at least one of mathematical and abstract principles to at least one of the current capacity and the future capacity.

11. The method of claim 8, wherein said determining a price reflects an inverse relationship between the cost-per-unit capacity and the appropriate capacity.

12. The method of claim 8 wherein when said appropriate capacity exceeds a threshold value, said determining a price reflects an inverse relationship between the cost-per-unit capacity and the appropriate capacity.

13. The method of claim 8, said determining a price comprising one of the mathematical processing of the appropriate capacity, and a modification of the mathematical processing of the appropriate capacity.

14. The method of claim 8, further comprising:
said providing access being effective to provide global access to the plurality of computer programs, but not to individual ones of the computer programs; and
determining a use fee to use one of the individual computer programs over a period of time based at least partially on a size of a sub-section of the site on which the one of the individual computer programs is resident.

15. The method of claim 14, wherein said sub-section is a logical partition of the site.

16. The method of claim 14, wherein said sub-section is a collection of the individual computers on which the one of the individual computer programs is resident.

17. A method for providing access to a provider's library of a plurality of computer programs, comprising:
determining an appropriate capacity of a site of a interested user at least partially from at least one of a current capacity of the site and a future capacity of the site;
determining a price at least partially from at least one of:
mathematical processing of at least the appropriate capacity and a period of time of desired access; and
consulting a record of at least one previous mathematical processing of at least the appropriate capacity and a period of time of desired access; and
receiving compensation consistent with the price; and
providing access to any of said plurality of computer programs.

18. The method of claim 17, further comprising:
said providing access being effective to provide global access to the plurality of computer programs, but not to individual ones of the computer programs;
determining a use fee to use one of the individual computer programs over a period of time based at least partially on a size of a sub-section of the site on which the one of the individual computer programs is resident.

19. The method of claim 18, wherein said sub-section is a logical partition of the site.

20. The method of claim 18, wherein said sub-section is a collection of the individual computers on which the one of the individual computer programs is resident.

21. The method of claim 17, the mathematical relationship comprising:
k (AC)^{z}
where:
AC is the appropriate capacity, and
k and z are variables.

22. The method of claim 17, wherein said determining a price reflects an inverse relationship between the cost-per-unit capacity and the appropriate capacity.

23. The method of claim 17 wherein when said appropriate capacity exceeds a threshold value, said determining a price reflects an inverse relationship between the cost per unit capacity and the appropriate capacity.

24. A method for pricing access to a plurality of libraries, each containing a plurality of computer programs, comprising:
determining an appropriate capacity of a site of a interested user;
determining a first price, based at least partially on a predetermined mathematical relationship to the appropriate capacity, for access to a first library of the plurality of libraries;
determining a second price, based at least partially on a predetermined mathematical relationship to the appropriate capacity, for access to a second library of the plurality of libraries;
offering, for the first price, access to the interested user for access to the first library; and
offering, for the second price, access to the intended user for access to the second library.

25. The method of claim 24, wherein a content of computer programs in said first library partially overlaps with the second library.

26. The method of claim 24, wherein the second library includes all of the programs in the first library.
